(19) United States
(12) Patent Application Publication
(10) Pub. No.: US 2006/0072371 A1
(43) Pub. Date: Apr. 6, 2006

(54) Mixing device and method

(76) Inventor: Trevor Hill, Port Macquarie (AU)

Correspondence Address: BROOKS KUSHMAN P.C., 1000 TOWN CENTER, TWENTY-SECOND FLOOR, SOUTHFIELD, MI, 48075, US

(21) Appl. No.: 10/543,641

(22) PCT Filed: Jan. 30, 2004
(86) PCT No.: PCT/AU04/00115

§ 371 Date: Jul. 28, 2005

(30) Foreign Application Priority Data
Jan. 31, 2003 (AU) 2003200352

(51) Int. Cl. B01F 11/00; B01F 13/00

(52) U.S. Cl. 366/130

(57) ABSTRACT

A mixing device for the mixing of quantities of ingredients, said device including a flexible sheet bounded by edges; said sheet formed into a basin having a base portion and side portions; said side portions formed by upwardly folding outer portions of said sheet; adjacent sides portions meeting to form respective corners at which said sheet is gathered to form respective pointed formations; each of said respective pointed formations attached to a corresponding handle.

The present invention relates to devices for the mixing of a plurality of ingredients into a homogenous preparation, and more particularly to a method for the mixing of the ingredients for the preparation of mortar or concrete.

### BACKGROUND

Manual means are normally employed for the mixing of mortar or concrete where relatively small quantities are required or no mechanical means are available. Typically the mixing is then accomplished in a wheelbarrow or on a flat surface with the use of a hoe or shovel. Both methods tend to be awkward and inefficient; especially so for small quantities.

Achieving a proper homogenous mix in a wheelbarrow is difficult as residues of dry sand or cement tend to adhere in the corners of the barrow, while mixing on a flat surface is awkward as the adding of water tends to cause spillage of both water and some of the ingredients of the mix over the edge of the surface.

It is an object of the present invention to address or ameliorate the above disadvantages or to provide a useful alternative.

### BRIEF DESCRIPTION OF INVENTION

Accordingly, in one broad form of the invention there is provided a mixing device for the mixing of quantities of ingredients, said device including a flexible sheet bounded by edges; said sheet formed into a basin having a base portion and side portions; said side portions formed by upwardly folding outer portions of said sheet; adjacent sides portions meeting to form respective corners at which said sheet is gathered to form respective pointed formations; each of said respective pointed formations attached to a corresponding handle.

Preferably said flexible sheet is impervious.

Preferably said flexible sheet is of sufficient stiffness to substantially maintain the shape of said basin when said device is prepared for use on a supporting surface.

Preferably said sheet is bounded by at least three edges to form a triangle.

Preferably said sheet is bounded by four edges to form a rectangle.

Preferably the ratio of the height of said side portions to the length of said base of said basin is in the range of between 1 to 3 and 1 to 5.

Preferably the ratio of the volume of said basin to the volume of a standard bag of dry-mix mortar or concrete is in the range of between 2.5 to 1 and 4 to 1.

Preferably each said respective handle is provided with at least one load-bearing edge and at least one friction-inducing aperture.

Preferably each said respective handle is adapted for attachment to one of said respective pointed formations by a combination of folding said pointed formation over at least one of said at least one load-bearing edge and passing said pointed formation through at least one of said at least one friction-inducing aperture.

Accordingly, in another broad form of the invention there is provided a method for the mixing of the ingredients of mortar or concrete with water, said method including the steps of;
(a) preparing a flexible impervious sheet folded into the shape of a basin, said basin fitted at said respective corners with respective handles,
(b) placing said basin on a supporting surface,
(c) placing said ingredients of said mortar or concrete in said basin,
(d) adding a desired quantity of water, repeating sequential raising and lowering said respective handles sufficient to cause said ingredients and said water to attain a homogenous mixture.

Accordingly, in yet another broad form of the invention there is provided a method for the mixing of the ingredients of mortar or concrete with water, said method including the steps of;
(a) preparing a flexible impervious sheet bounded by three edges folded into the shape of a three sided basin having three corners with a triangular base, said basin fitted at each one of respective said corners with respective handles,
(b) attaching one of said handles to a support means adapted to maintain said base in contact with a supporting surface,
(c) placing said ingredients of said mortar or concrete in said basin with a desired quantity of water,
(d) a person grasping each of said handles not attached to said supporting means and repeatedly sequentially raising and lowering said handles sufficient to cause said ingredients and said water to attain a homogenous mixture.
(e) maintaining the bulk of the weight of said ingredients of said mortar or concrete and said water supported by said supporting surface,
(f) pouring said homogenous mixture from said basin into a desired position.

Accordingly, in yet another broad form of the invention there is provided a method for the mixing of the ingredients of mortar or concrete with water, said method including the steps of;
(a) preparing a flexible impervious sheet bounded by four edges folded into the shape of a four sided basin having four corners with a generally rectangular base, said basin fitted at each one of respective said corners with respective handles,
(b) placing said ingredients of said mortar or concrete in said basin with a desired quantity of water,
(c) a first one of two persons grasping each of two of said handles and a second one of said two persons grasping remaining ones of said handles,
(d) each of said two persons alternately sequentially raising and lowering said handles sufficient to cause said ingredients and said water to attain a homogenous mixture.

Accordingly, in yet another broad form of the invention there is provided a method for the mixing of volumes of disparate particulate materials, said method including the steps of;
(a) preparing a flexible sheet bounded by edges folded into the shape of a basin comprising a base with sides; adjoining ones of said edges meeting at corners; said basin fitted at each respective corner with respective handles,
(b) placing said basin on a supporting surface,
(c) placing said volumes of disparate particulate material in said basin,
(d) urging each of said handles repeatedly and sequentially in a generally raising and lowering motion sufficient to cause said disparate particulate material to attain a homogenous mixture,

Accordingly, in another broad form of the invention there is provided a method for the forming of a basin from a sheet of material for the mixing of quantities of ingredients, said method including the steps of:
(a) selecting at each corner of a generally flat sheet of flexible material bounded by edges, a first one of two points lying at a preferred distance from said corner along a first one of said edges defining said corner and a second one of said two points lying at an equal said preferred distance from said corner along a second one of said edges defining said corner,
(b) bringing the said two points at said corner together so as to urge the portions of said edges between each one of said two points and said corner towards each other sufficient to form generally upwardly curving sections of said sheet of material at said corner,
   gathering that portion of said sheet of material between said two points and said corner into a generally pointed formation suitable for threading into, and attachment to, a handle.

### BRIEF DESCRIPTION OF THE DRAWINGS

Embodiments of the present invention will now be described with reference to the accompanying drawings wherein:

FIG. 1 is a perspective view of a preferred embodiment of the present invention in a first stage of construction,

FIG. 2 is a view of the embodiment of FIG. 1 at a final stage of construction,

FIG. 3 is a view of a first form of a handle component of the embodiment of FIGS. 1 and 2 prior to assembly,

FIG. 3A is a view of the handle component of FIG. 3 after assembly,

FIG. 4 is a view of a second form of a handle component of the embodiment of FIGS. 1 and 2 prior to assembly,

FIG. 4A is a view of the handle component of FIG. 4 after assembly,

FIG. 5 is a view of a third form of a handle component of the embodiment of FIGS. 1 and 2 prior to assembly,

FIG. 5A is a view of the handle component of FIG. 5 after assembly,

FIG. 6 is a view of a fourth form of a handle component of the embodiment of FIGS. 1 and 2 prior to assembly,

FIG. 6A is a sectioned view of the handle component of FIG. 6 after assembly.

FIG. 7A is an elevation view of a fifth view of a handle component of the embodiment of FIGS. 1 and 2 prior to assembly.

FIG. 7B is a sectioned side view of the handle component of FIG. 7A after assembly.

FIG. 8A is an illustration of a first stage of a preferred method of preparation for assembly,

FIG. 8B is an illustration of a second stage of the preferred method of FIG. 8A.

### DETAILED DESCRIPTION OF PREFERRED EMBODIMENTS

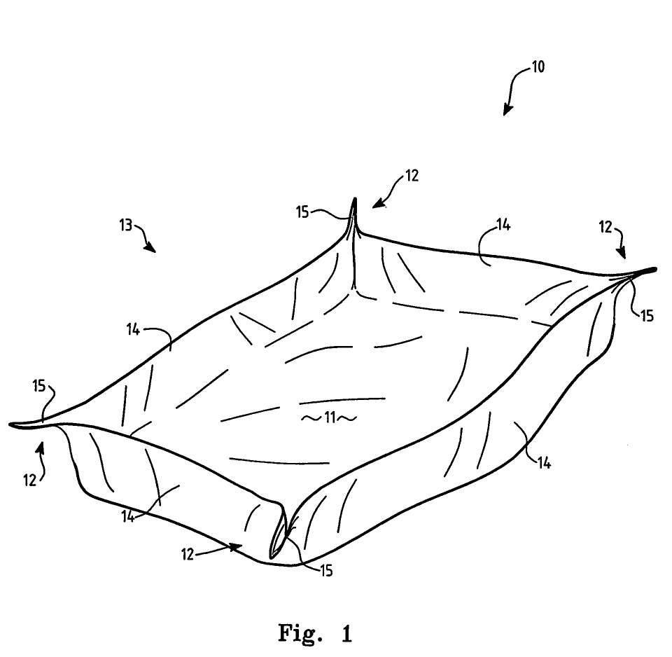

With reference to FIG. 1, mixing device 10 is comprised of a flexible, generally rectangular sheet 11 gathered at the four corners 12 so as to form a generally rectangular basin 13 having folded-up sides 14. The sheet material is impervious and is sufficiently stiff to retain the general basin shape when the device is assembled and is arranged on a supporting surface.

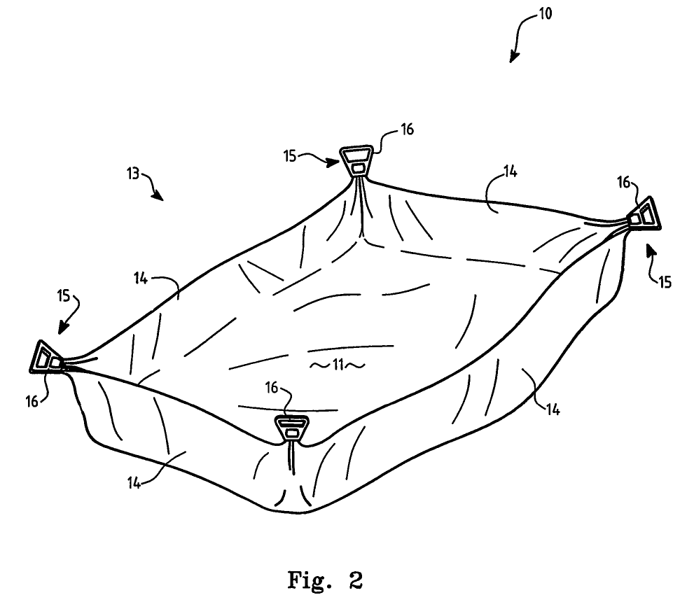

The process of forming folded-up sides 14 causes folds of excess material at each of the four corners 12 which are bunched into elongate gathered formations 15. As shown in FIG. 2, each of formations 15 is attached to a handle 16. In preferred embodiments handle 16 is comprised of a gripping portion adapted to fit the hand of a user and an attachment portion adapted to connect to the formation 15.

Preferred ratios of the height of the sides 14 to the length of the basin lie in the range of between 1 to 3 and 1 to 5. The dimensions of the basin are preferably chosen such that a typical bag of dry-mix mortar or concrete can be accommodated for mixing as described below. Preferred ratios of the volume of the basin to that of a standard proprietary bag of dry-mix mortar or concrete lie in the range of between 2.5 to 1 and 4 to 1.

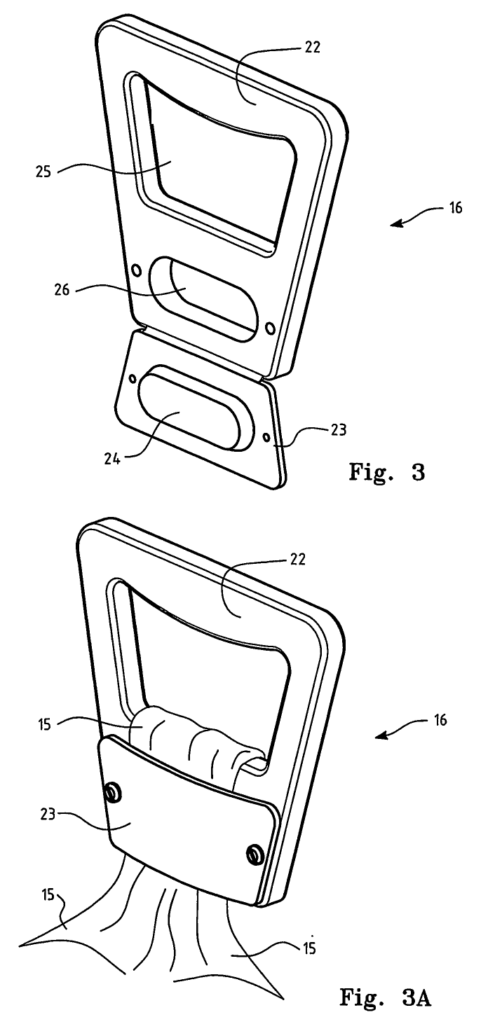

In a first preferred form as shown in FIG. 3, handle 16 is formed from an injection moulded polymer having a gripping portion 22 and a hinged retaining portion 23 provided with projecting section 24. The material of formation 15 in this form of the handle is fed through the handle opening 25 and thence through opening 26 after which hinged retaining portion 23 is rotated to enter opening 26 trapping the material of formation 15. The hinged retaining portion may be locked in this position by means of for example, screws or rivets so as to firmly attach formation 15 to handle 16 as shown in FIG. 3A.

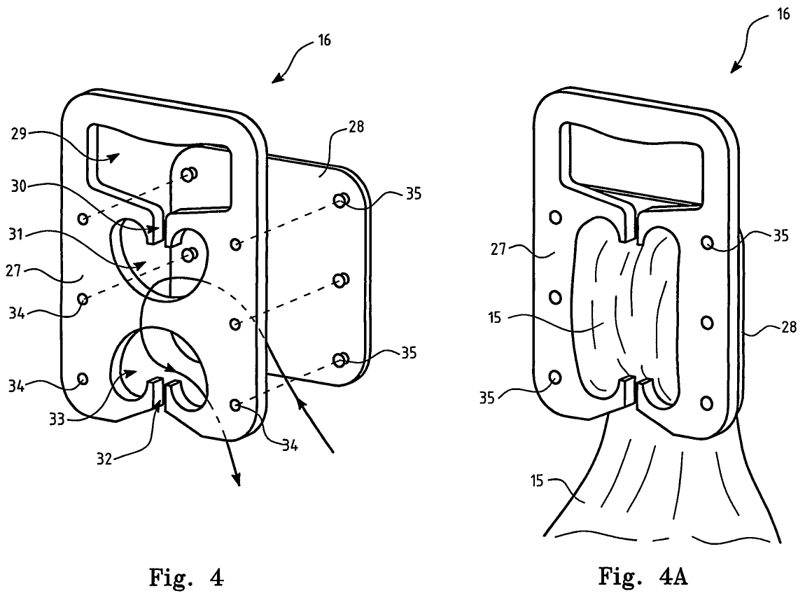

In a second preferred form as shown in FIG. 4 handle 16 is moulded into two portions comprising a handle plate 27 and a retainer plate 28. In this case, a suitable length of the material of formation 15 is first fed through handle opening 29 and drawn through upper gap 30 into first holding aperture 31. The material is then drawn around the base of handle plate 27 and drawn through lower gap 32 into second holding aperture 33. Retainer plate 28 is then assembled to handle plate 27 by for example, mating arrays of holes 34 and snap-fit lugs 35 so as to attach formation 15 firmly to handle 16 as shown in FIG. 4A.

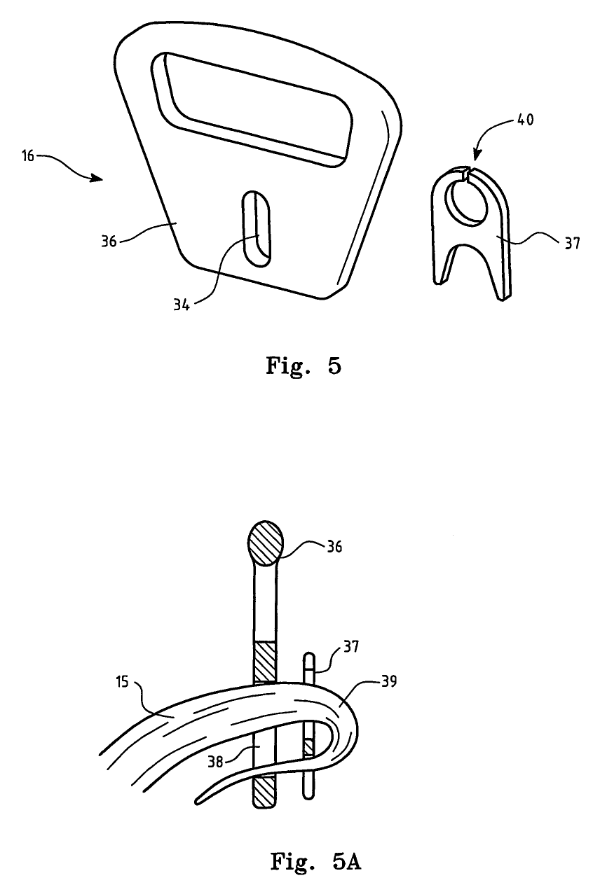

In a third preferred form as shown in FIG. 5 handle 16 is in the form of moulded handle plate 36 and retainer clip 37. In this case the outer end of the material of formation 15 is formed into a ‘U’ shape (as shown in FIG. 5A). The base of the ‘U’ is then fed through slot 38 of the handle plate 36 far enough to engage retainer clip 37 with the leg 39 of the ‘U’ by means of gap 40. Retainer clip 37 is larger than slot 38 thus trapping the material of formation 15 when this is pulled back to seat clip 37 against handle plate 36 as shown in FIG. 5A.

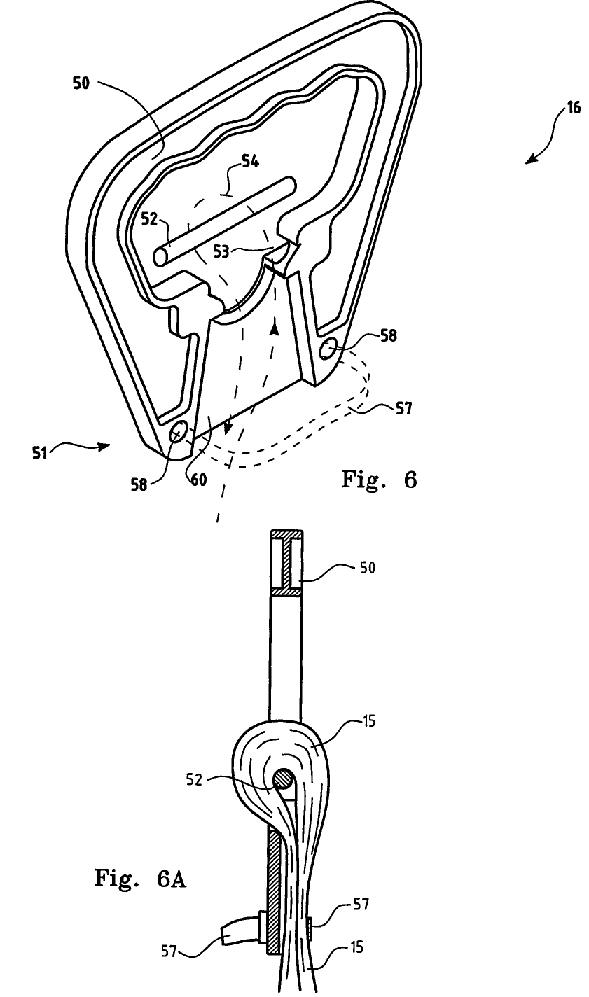

In fourth preferred form of a handle according to the invention, with reference to FIGS. 6 and 6A, there is provided a moulded handle 16 having a gripping portion 50 and a retaining portion 51. Handle 16 is further provided with dowel 52 which nests in recess 53 when the handle is attached to gathered formation 15. In this embodiment of the handle 16 the material of gathered formation 15 is fed around dowel 52 as shown by dashed path 54. The outer end 59 of formation 15 is pulled to pass through scalloped opening 55 as dowel 52 is pushed into recess 53, effectively trapping the material of formation 15 between dowel 52 and the edge 56 of opening 55. A suitable tying means 57, such as for example, a cable tie is then inserted through holes 58 and tightened to compress the material of gathered formation 15 into recess 60.

In each of the above described preferred forms of handle 16 the path of the material of the gathered formation 15 is such as to form a sharply folded region over a load bearing edge or member. The remainder of the outer portion of the formation is further constrained in a manner to provide sufficient additional friction to prevent the material pulling from the handle when the device is in use.

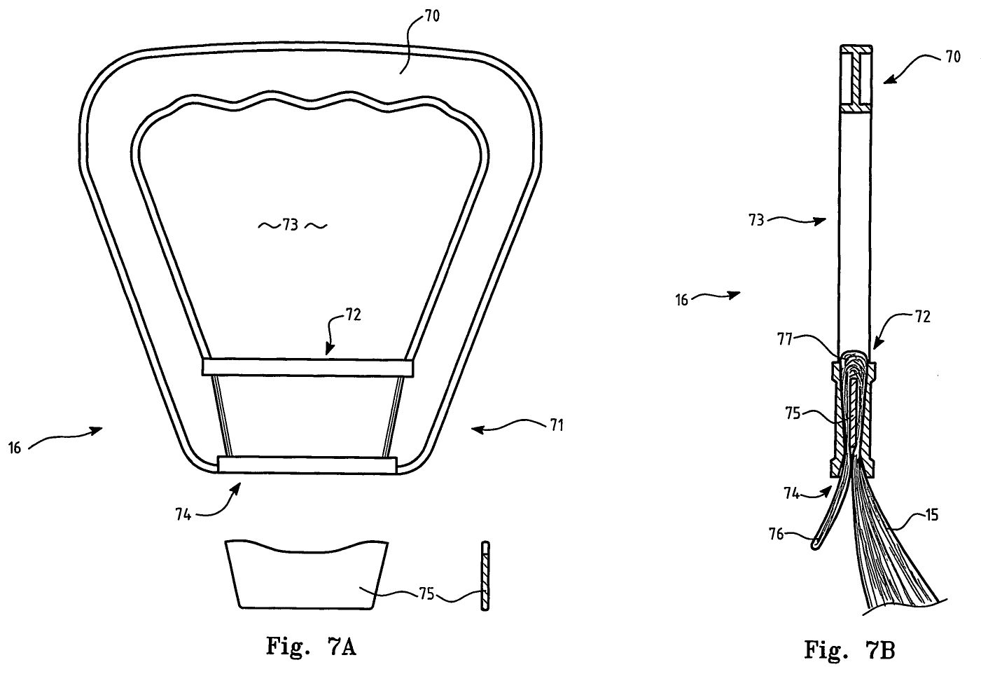

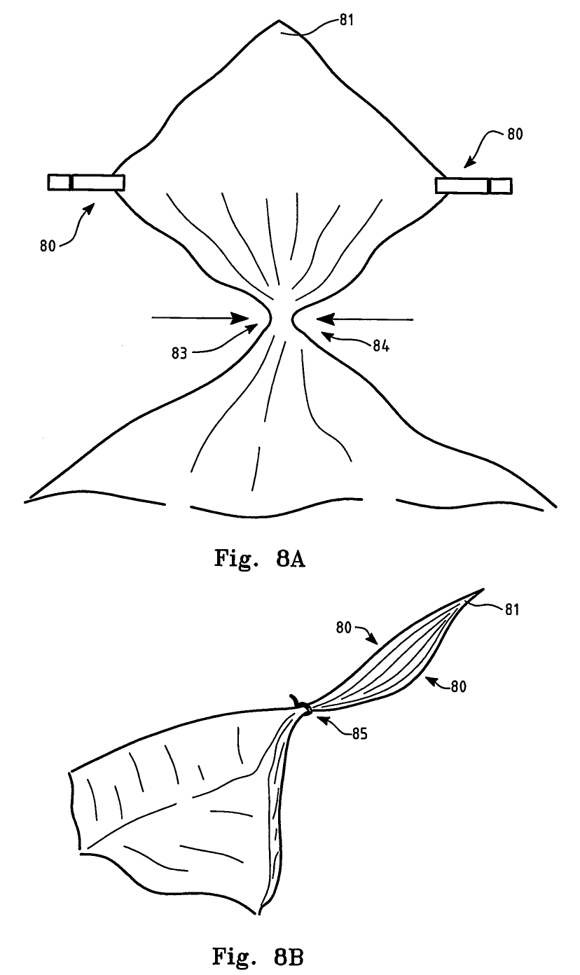

In a fifth preferred form of a handle according to the invention as shown in FIGS. 7A and 7B, there is provided a moulded handle 16 having a gripping portion 7D and a retaining portion 71. Gripping portion 71 is formed so as to provide a wedge-shaped cavity 72 having apertures communicating with the central portion 73 and the underside 74 of handle 16. Preferably, cavity 72 is wedge-shaped in both length and width. Handle 16 is further provided with a wedge plate 75 adapted for insertion into cavity 72 and so dimensioned as to leave a gap between the surfaces of wedge plate 75 and cavity 72 when assembled as shown in FIG. 7B.

In this form of the handle 16 the material of gathered formation 15 is firstly fed upwardly through the aperture at the underside 74 of handle 16 and through cavity 72 so as to project into central portion 73 sufficient to allow the outer end 76 of gathered formation 15 to be folded over and pushed back downwardly into cavity 72. Wedge plate 75 is then inserted into the loop 77 now formed by gathered formation 15 and both the loop of material and the wedge pulled downwardly into cavity 72 until firmly wedged in the cavity.

The forming of the basin, its depth and hence its other relative dimensions for a given sheet of material, is determined by the manner of gathering the material at the four corners prior to the attachment of the handles.

In a preferred procedure, the sheet of material is laid out flat on a suitable surface. As shown in FIG. 7A and 7B, two points 80 lying equidistant along each of the edges from a corner 81 of the sheet 82 are initially clamped or weighted down so as to maintain this initial position. Then two further points 83 and 84 lying along each edge, again equidistant from the corner by approximately at twice the distance as for point 81 and 82, are pulled together and the material so gathered tied with, for example, a self adjusting cable tie 85.

When this process has been completed for each corner, the effect is to draw the material adjoining the tied points upwardly relative to the middle of the sheet thus forming side-like formations surrounding a base portion; in effect approximating a basin. The material lying between the tied point and the corners may now be gathered for feeding through, and attachment to the handles.

When assembled, material 11 and handles 16 may conveniently be bundled into a suitable container for transport and storage, such as for example in a polythene bag or in a canister such as a paint tin.

In use the device is spread out on a suitable surface to form the basin 13; typically this will be the floor or ground close to where the mortar or concrete mix is to be used. A bag of dry-mix mortar or concrete is then deposited in the basin. Alternately smaller quantities of ingredients may be placed in the basin as desired.

Water is then added in the desired or recommended quantity and the mixing process follows according to a first preferred sequence. Two people each grasp two adjoining handles allowing the bulk of the weight of the ingredients to remain supported on the floor or ground. One person, (the first person) commences with either the right or left hand to tug upward on the handle in that hand thus causing the ingredients to be displaced towards the second person. The first person repeats this action with the other hand and then continues the sequence for each hand, tugging upward and lowering the handles a number of times. The second person now duplicates this procedure. Both persons may continue to alternately repeat the process as required.

The effect of these motions is to repeatedly roll over the ingredients within the confines of the basin causing a rapid and thorough intermingling of all particles and water resulting in a homogenous mix of mortar or concrete.

After mixing, the mortar or concrete can be carried in the basin and poured out into its desired location.

In a second preferred method of use, a single person may effect the mixing process after preparing at least one but preferably two suitable hooks from a support at the height of approximately one meter and separated (in the case of two hooks) by approximately the width of the basin. Although mixing may be effected with two handles supported from the one hook, for best results, two handles should each be supported by its own hook. For this method the remaining two handles are then grasped by the single person. Again the bulk of the weight of the ingredients placed in the basin remains supported on the floor or ground as the single person now alternately raises and lowers his or her two handles.

Although the above descriptions reference the mixing of mortar or concrete it will be clear that the device may be used for the mixing of any combination of disparate loose material into a homogenous preparation.

The above describes only some embodiments of the present invention and modifications, obvious to those skilled in the art, can be made thereto without departing from the scope and spirit of the invention.

1. A mixing device for the mixing of quantities of ingredients, said device including a flexible sheet bounded by edges; said sheet formed into a basin having a base portion and side portions; said side portions formed by upwardly folding outer portions of said sheet; adjacent sides portions meeting to form respective corners at which said sheet is gathered to form respective pointed formations; each of said respective pointed formations attached to a corresponding handle.

2. The device of claim 1 wherein said flexible sheet is impervious.

3. The device of claim 2 wherein said flexible sheet is of sufficient stiffness to substantially maintain the shape of said basin when said device is prepared for use on a supporting surface.

4. The device of claim 3 wherein said sheet is bounded by at least three edges to form a triangle.

5. The device of claim 3 wherein said sheet is bounded by four edges to form a rectangle.

6. The device of claim 4 wherein the ratio of the height of said side portions to the length of said base of said basin is in the range of between 1 to 3 and 1 to 5.

7. The device of claim 1 wherein the ratio of the volume of said basin to the volume of a standard bag of dry-mix mortar or concrete is in the range of between 2.5 to 1 and 4 to 1.

8. The device of claim 7 wherein each said respective handle is provided with at least one load-bearing edge and at least one friction-inducing aperture.

9. The device of claim 8 wherein each said respective handle is adapted for attachment to one of said respective pointed formations by a combination of folding said pointed formation over at least one of said at least one load-bearing edge and passing said pointed formation through at least one of said at least one friction-inducing aperture.

10. A method for the mixing of the ingredients of mortar or concrete with water, said method including the steps of;
(a) preparing a flexible impervious sheet folded into the shape of a basin, said basin fitted at said respective corners with respective handles,
(b) placing said basin on a supporting surface,
(c) placing said ingredients of said mortar or concrete in said basin,
(d) adding a desired quantity of water,
(e) repeating sequential raising and lowering said respective handles sufficient to cause said ingredients and said water to attain a homogenous mixture.

11. A method for the mixing of the ingredients of mortar or concrete with water, said method including the steps of;
(a) preparing a flexible impervious sheet bounded by three edges folded into the shape of a three sided basin having three corners with a triangular base, said basin fitted at each one of respective said corners with respective handles,
(b) attaching one of said handles to a support means adapted to maintain said base in contact with a supporting surface,
(c) placing said ingredients of said mortar or concrete in said basin with a desired quantity of water,
(d) a person grasping each of said handles not attached to said supporting means and repeatedly sequentially raising and lowering said handles sufficient to cause said ingredients and said water to attain a homogenous mixture,
(e) maintaining the bulk of the weight of said ingredients of said mortar or concrete and said water supported by said supporting surface,
(f) pouring said homogenous mixture from said basin into a desired position.

12. A method for the mixing of the ingredients of mortar or concrete with water, said method including the steps of;
(a) preparing a flexible impervious sheet bounded by four edges folded into the shape of a four sided basin having four corners with a generally rectangular base, said basin fitted at each one of respective said corners with respective handles,
(b) placing said ingredients of said mortar or concrete in said basin with a desired quantity of water,
(c) a first one of two persons grasping each of two of said handles and a second one of said two persons grasping remaining ones of said handles,
(d) each of said two persons alternately sequentially raising and lowering said handles sufficient to cause said ingredients and said water to attain a homogenous mixture.

13. A method for the mixing of volumes of disparate particulate materials, said method including the steps of;
(a) preparing a flexible sheet bounded by edges folded into the shape of a basin comprising a base with sides; adjoining ones of said edges meeting at corners; said basin fitted at each respective corner with respective handles,
(b) placing said basin on a supporting surface,
(c) placing said volumes of disparate particulate material in said basin,
(d) urging each of said handles repeatedly and sequentially in a generally raising and lowering motion sufficient to cause said disparate particulate material to attain a homogenous mixture.

14. A method for the forming of a basin from a sheet of material for the mixing of quantities of ingredients, said method including the steps of:
(a) selecting at each corner of a generally flat sheet of flexible material bounded by edges, a first one of two points lying at a preferred distance from said corner along a first one of said edges defining said corner and a second one of said two points lying at an equal said preferred distance from said corner along a second one of said edges defining said corner,
(b) bringing the said two points at said corner together so as to urge the portions of said edges between each one of said two points and said corner towards each other sufficient to form generally upwardly curving sections of said sheet of material at said corner,
(c) gathering that portion of said sheet of material between said two points and said corner into a generally pointed formation suitable for threading into, and attachment to, a handle.
